(19) United States
(12) Patent Application Publication
(10) Pub. No.: US 2005/0186005 A1
(43) Pub. Date: Aug. 25, 2005

(54) Keyboard with thumb position

(76) Inventor: Shigeki Maeda, Yokosuka-City (JP)

Correspondence Address: Shigeki Maeda, 2 - 80 - 10 - 1004 Kamoi, Yokosuka, Kanagawa-Pre., 239 - 0813, JP

(21) Appl. No.: 11/062,002

(22) Filed: Feb. 22, 2005

Related U.S. Application Data
(60) Provisional application No. 60/546,359, filed on Feb. 20, 2004.

(51) Int. Cl. B41J 5/08

(52) U.S. Cl. 400/490

(57) ABSTRACT

This invention is about a keyboard with pockets to help keep thumb positions. Specially designed pockets to make it sure to keep thumbs always stay on a space bar-cap of a QWERTY keyboard or on a 0 key-cap of a numeric keyboard.

### CROSS-REFERENCE TO PELATED APPLICATION

This application claims the benefit of U.S. Provisional Application No. 60/546,359, filed Feb. 20, 2004.

### BACKGROUND OF THE INVENTION

This invention is about a keyboard that makes it easier to keep base positioning of fingers at a time of touch-typing or typing and helps key-input more comfortably than by any traditional keyboard of this kind as far as QWERTY keyboards for computers, word processors, etc., and numeric keyboard for calculators, cash registers, etc. are concerned. Precedent technique concerning this invention is a ridge on a cap of ‘5’ key of a numeric keyboard and that on both ‘J’ and ‘F’ keys of a QWERTY keyboard. These ridges are base points where all fingers are surely invited back to base positioning.

This precedent technique, however, required people to find ridges with an index or a middle finger of both hands every time they come back to base positioning while touch typing.

There are also some typists that feel uncomfortable at physically touching on ridges each time they type on the ‘J’, ‘F’ and ‘5’ keys.

Furthermore, as long as a traditional QWERTY keyboard is concerned, people shift their index fingers of both hands, the base points, only to leave the base positioning for such keys as Esc, Functions, Delete, etc., that are in a top row, and such keys as Back Space, Enter, etc. on the right end of a keyboard.

In other words, people have to move whole hands away from the base positions.

In order to come back to base positions, they need to find ridges first on the ‘J’ and ‘F’ keys with index fingers, which means it is not possible to make an instant return to base positions.

Base positioning based on index fingers is a main cause of this problem.

### SUMMARY OF THE INVENTION

The first object we aimed in this invention is to provide a keyboard that realizes easier base positioning than traditional ones at a time of touch typing.

The second object is to provide a keyboard that does not require any ridges.

The third object is to provide a keyboard that does not require people specifically find the ‘J’ key and the ‘F’ key out of many keys, or find ridges on them every time they come back to base positions while touch typing or typing.

Further object is put on providing a QWERTY keyboard that enables people to type any key with any finger without shifting their hands away from home positions.

### BRIEF DESCRIPTION OF THE DRAWINGS

FIG. 1 is a perspective view showing base positioning with a traditional QWERTY keyboard in a full size.

FIG. 2 is a perspective view of a first QWERTY keyboard with thumb positions of this invention.

FIG. 3 is a perspective view showing base positioning with the first QWERTY keyboard with thumb positions of this invention.

FIG. 4 is a cross-sectional view of a space bar-cap along with a right-hand thumb taken at line IV--IV in FIG. 3.

FIG. 5 is a perspective view showing a typist is working on the first QWERTY keyboard with pockets of this invention.

FIG. 6 is a perspective view a second QWERTY keyboard with thumb positions of this invention.

FIG. 7 is a perspective view showing base positioning with the second QWERTY keyboard with thumb positions of this invention.

FIG. 8 is a perspective view showing base positioning with a numeric keypad.

FIG. 9 is a perspective view of a numeric keyboard with thumb position of this invention.

FIG. 10 is a perspective view showing base positioning with the numeric keyboard with thumb position of this invention.

FIG. 11 is a perspective view of a modification to the first QWERTY keyboard with thumb positions of this invention.

FIG. 12 is a cross-sectional view of a space bar-cap along with a right-hand thumb taken at line XII--XII in FIG. 11.

### DETAILED DESCRIPTION OF THE INVENTION

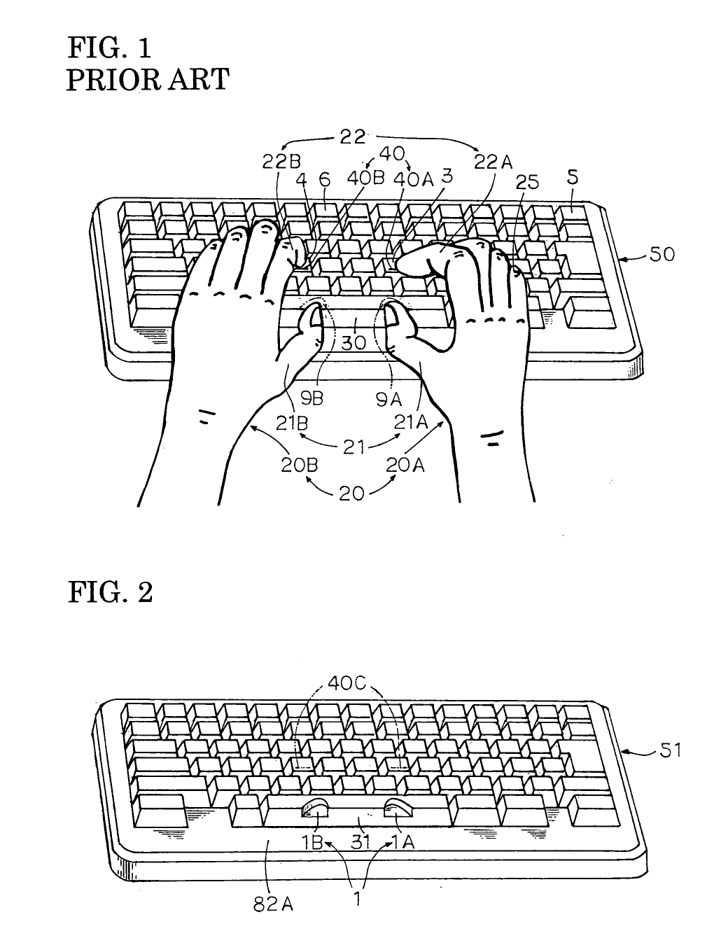

FIG. 1 shows base positioning with a traditional QWERTY keyboard 50 in a full size.

A right-hand index 22A is put on a ‘J’ key 3 and a left-hand index 22B on an ‘F’ key 4. Thumbs 21 are lightly touching on a space bar-cap 30, while other fingers are respectively positioned. Typists must importantly keep an accurate picture of base positioning in mind.

FIG. 2 shows the first QWERTY keyboard with thumb positions 51 as explained in claim 1. This is a further development after the QWERTY keyboard 50 per FIG. 1 having a right-side pocket 1A on a right side 9A of the space bar-cap 30 where a right-hand thumb 21A is expected to come and a left-side pocket 1B on a left side 9B where a left-hand thumb 21B is expected to come.

The right side-pocket 1A is for base positioning with the right-hand thumb 21A and the left side-pocket 1B with the left-hand thumb 21B. No ridges 40C are provided with the QWERTY keyboard 51 in this invention and regardless of whether it has or not, it is not functionally affected.

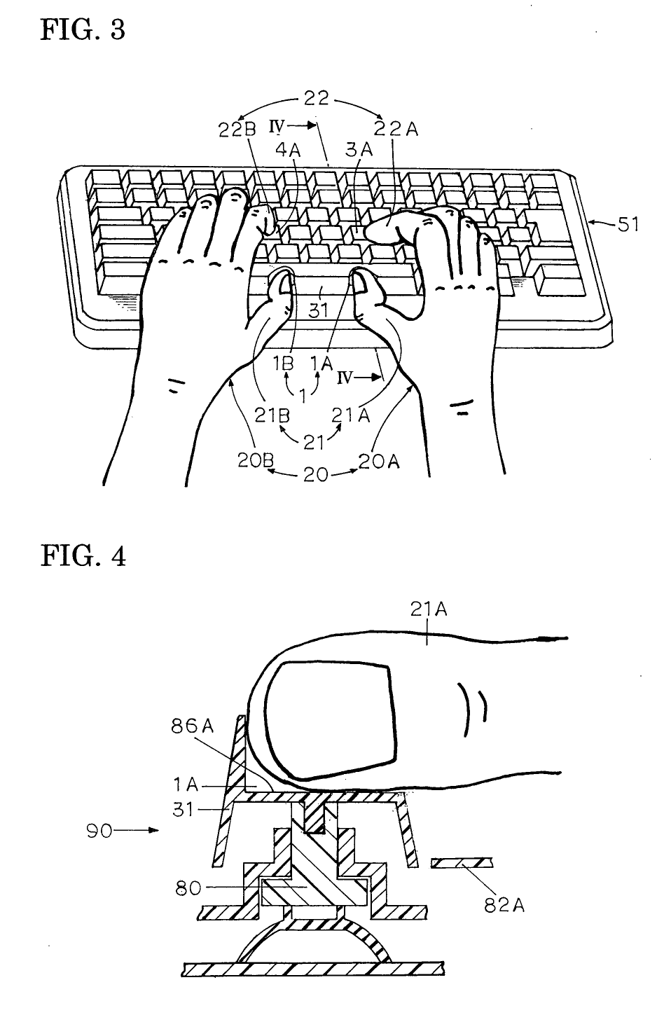

FIG. 3 shows base positioning for the first QWERTY keyboard 51 in this invention. This image gives you an idea about how thumbs 21 are positioned for base positioning.

Start with finding the right-side pocket 1A with the right-hand thumb 21A and the left-side pocket 1B with the left-hand thumb 21B at a time of touch typing. Put thumbs on the pockets 1 respectively.

Instant the fingers are put on the pockets 1, the right-hand index 22A is automatically invited to a ‘J’ key 3A and the left-hand index 22B to an ‘F’ key 4A.

Base positioning is possible in a blink of time only by putting thumbs 21 on pockets 1. Typists in general remember base positioning almost very accurately.

Since the pockets 1 are larger than the ridges 40, it is easier to find the pockets 1 with both thumbs 21 than to find the ridges 40 with both index fingers 22.

FIG. 4 shows a cross-sectional view of a space bar-cap 31 along with a right-hand taken on IV--IV in FIG. 3.

Instant the right-hand thumb 21A is put on the right-side pocket 1A, base positioning is possible as shown on FIG. 4.

Same procedure for the left-hand thumb 21B follows to complete base positioning per FIG. 3. Of course thumbs 21 must be pressed down to input on a space bar 90.

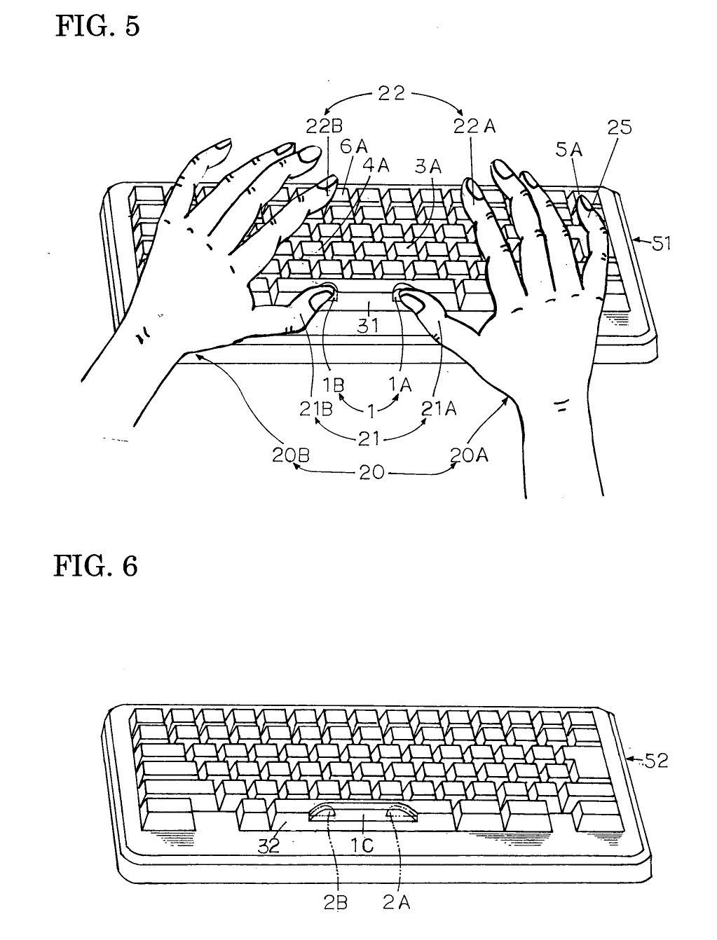

FIG. 5 shows a view on which a typist is working on the first QWERTY keyboard 51 with pockets 1 as explained in claim 1 for this invention. It explains how a right-hand little finger 25 goes for a Delete key 5A and how the left-hand index 22B goes for a ‘F6’ key 6A.

With a traditional base positioning per FIG. 1, the right-hand index 22A leaves from the ‘J’ key 3 when trying to reach a Delete key 5 with the right-hand little finger 25, and the left-hand index 22B leaves from the ‘F’ key 4 to reach ‘F6’ key 6 with the left-hand index 22B.

Consequently people tried to find ridges 40 on the ‘J’ key 3 and the ‘F’ key 4 at the time of touch typing and the ‘J’ key 3 and the ‘F’ key 4 at a time of typing.

However, in this invention it is now possible to make the right-hand index 22A instantly return to the ‘J’ key 3A after in-putting on the Delete key 5A with the right-hand index 22A, and also the left-hand index 22B back to the ‘F’ key 4A after the ‘F6’ key 6A with the left-hand index 22B.

The first QWERTY keyboard 51 of this invention realizes any fingers possible to reach any keys as they keep both thumbs 21 on pockets 1 that are base points for base positioning.

Since typists remember base positioning, they know where to return quite instantly.

It has been troublesome with the traditional QWERTY keyboard 50 to find ridges 40 on the ‘J’ key 3 and the ‘F’ key 4 with index fingers 22 at a time of touch typing every time they return to base positioning.

Same thing is said about typing. However, the first QWERTY keyboard 51 of this invention made free from these troubles.

Once thumbs 21 are put on pockets, typists reasonably no longer have to shift thumbs 21 that are the base points for base positioning until typing is finished.

FIG. 6 shows the second QWERTY keyboard with thumb positions 52 as explained in claim 2. The second QWERTY keyboard 52 is further developed after the first QWERTY keyboard 51 explained in claim 1. The right-side pocket 1A and the left-side pocket 1B on the space bar-cap 31 are connected into one pocket 1C.

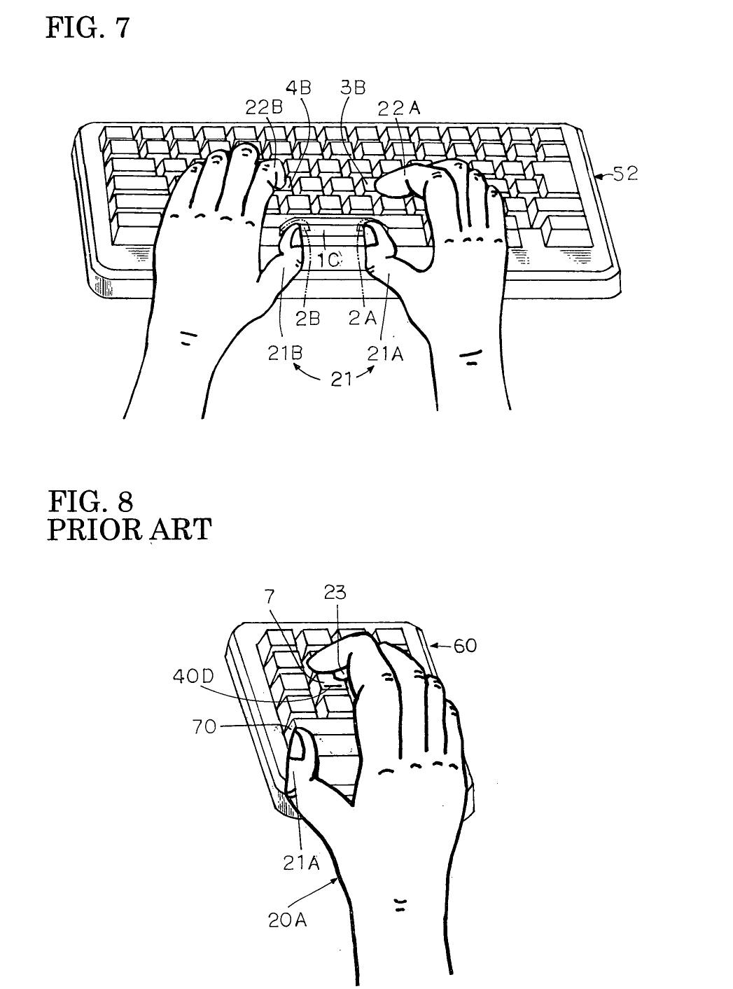

FIG. 7 shows base positioning with the second QWERTY keyboard 52.

At the same time the right-hand thumb 21A is put on a right side 2A and the left-hand thumb 21B on a left side 2B of the pocket 1C, base positioning is ready.

Effect of this invention, in addition to the one in claim 1, is it is easier to find the pocket 1C.

FIG. 8 shows base positioning with a numeric keypad.

A right-hand thumb 21A is put on a ‘0’ key 70, while a right-hand middle finger 23 are lightly touching on a ‘5’ key 7. Typists must importantly keep an accurate picture of base positioning in mind.

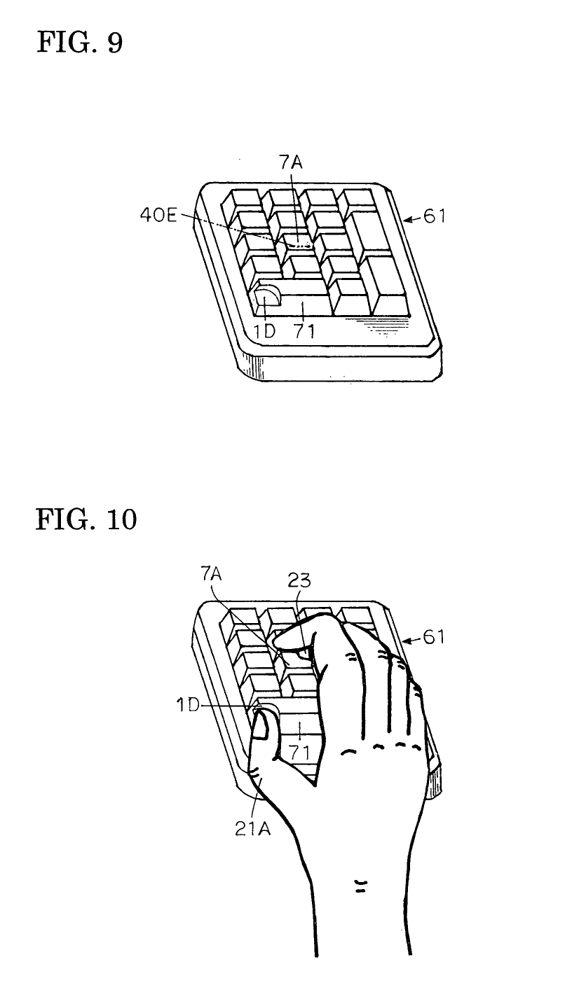

FIG. 9 shows a numeric keyboard with thumb position 61 as explained in claim 3. This is a further development after the numeric keypad 60 per FIG. 8 having a pocket 1D on a ‘0’ key-cap 71 where a right-hand thumb 21A is expected to come.

The pocket 1D is for base positioning with the right-hand thumb 21A.

No ridges 40E are provided with the numeric keyboard 61 in this invention and regardless of whether it has or not, it is not functionally affected.

FIG. 10 shows base positioning for the numeric keyboard 61 in this invention. This image gives you an idea about how the right-hand thumb 21A is positioned for base positioning.

Start with finding the pocket 1D with the right-hand thumb 21A at a time of touch typing. Put the right-hand thumb 21A on the pocket 1D. Instant the fingers are put on the pockets 1, the right-hand middle finger 23 is automatically invited to a ‘5’ key 7A.

Base positioning is possible in a blink of time only by putting the right-hand thumb 21A on the pocket 1. Typists in general remember base positioning almost very accurately.

Since the pockets 1 are larger than the ridge 40E, it is easier to find the pocket 1D with the right-hand thumb 21A than to find the ridges 40D with the right-hand middle finger 23.

It goes without saying further development and other various modifications are possibly made to this keyboard.

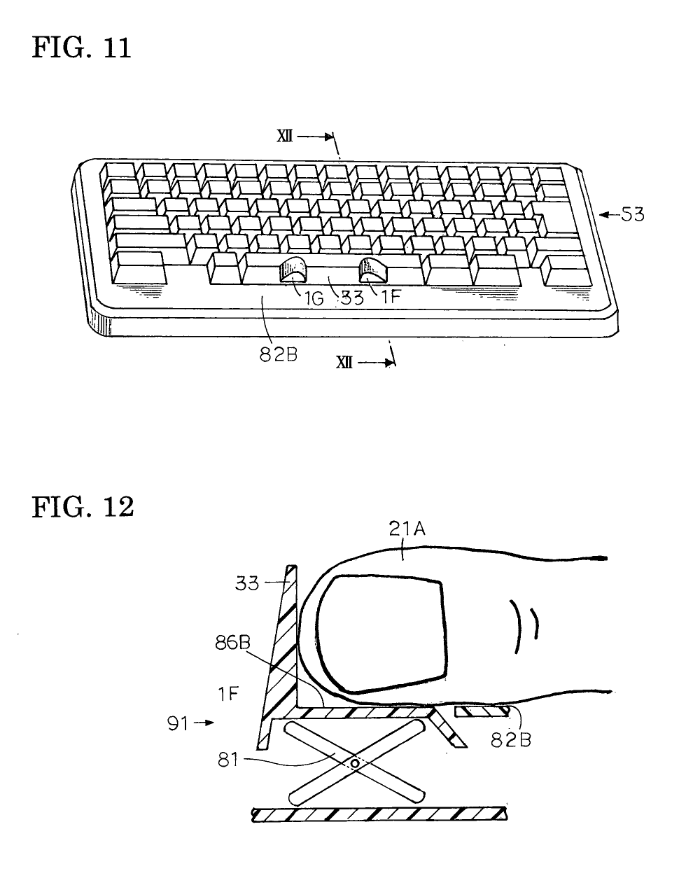

For example, FIG. 11 shows a third QWERTY keyboard with thumb positions 53 which a modification to the first QWERTY keyboard 51 in this invention per claim 1.

FIG. 12 is a cross-sectional view of a space bar-cap 33 along with a right-hand thumb 21A taken on XII-XII in FIG. 11.

Although a bottom 86B of a pocket 1F and a top surface 82B of the third QWERTY keyboard 53 casing is not horizontally on the same level as seen on FIG. 2, a modification is made to have both on the same level using a key switch system of pantograph mechanism 81 that is used for many QWERTY keyboards for lap-top computers.

One of the characteristics of this modification is: thumbs 21 are more comfortable at a time of typing than with the first QWERTY keyboard in claim 1 per FIG. 2 because thumbs can rest on a casing.

Like this modification suggests, depth of pocket for a space bar-cap as explained in claim 1 and 2 of this invention for a QWERTY keyboard and a ‘0’ key-cap of a numeric keyboard in claim 3 can be freely designed according to a type of key switch.

This invention of QWERTY keyboard with pockets for thumbs positioning includes QWERTY keyboard for word processors, typewriters and so on not limited to that for computers only. Also numeric keyboard for calculators, cash registers and etc. not limited to numeric keypad for computers.

Summing up effects of the keyboard in this invention;

First:

Moment thumbs are put on pockets, base positioning is formed. In other words there is little trouble finding a ridge on a ‘J’ key or an ‘F’ key, or that on a ‘5’ key, neither a letter on each of them.

Secondly:

The keyboard of this invention requires no ridges; therefore, such typists as feel uncomfortable touching a ridge on the ‘J’ key or the ‘F’ key, or on a ‘5’ key with their index fingers or a middle finger may choose to use a keyboard of non-ridge type.

Thirdly:

With this QWERTY keyboard invention, typists do not have to leave their thumbs from the pockets, the base points for base positioning, until typing is finished once they put both thumbs there.

1. A QWERTY keyboard comprising:
A right-side pocket to help keep a right-hand thumb and a left-side pocket to help keep a left-hand thumb are formed on a space bar-cap.

2. The QWERTY keyboard as claimed in claim 1, in which is further developed to have the right-side pocket and the left-side pocket connected all the way on the space bar-cap to help keep both thumbs in one pocket.

3. A numeric keyboard comprising:
A pocket to help keep a right-hand thumb is formed on a 0 key-cap.
